(19) United States
(12) Patent Application Publication
(10) Pub. No.: US 2005/0234909 A1
(43) Pub. Date: Oct. 20, 2005

(54) Method, computer program product, and data processing system for source verifiable audit logging

(75) Inventors: Steven A. Bade, Georgetown, TX (US); Ryan Charles Catherman, Raleigh, NC (US); James Patrick Hoff, Raleigh, NC (US); Nia Letise Kelley, Austin, TX (US); Emily Jane Ratliff, Austin, TX (US)

Correspondence Address: Duke W. Yee;Carstens, Yee & Cahoon, LLP, P.O. Box 802334, Dallas, TX, 75380, US

(73) Assignee: International Business Machines Corporation, Armonk, NY (US)

(21) Appl. No.: 10/825,187

(22) Filed: Apr. 15, 2004

(51) Int. Cl. G06F 7/00

(52) U.S. Cl. 707/8

(57) ABSTRACT

A method, computer program product, and a data processing system for logging audit events in a data processing system. A sequence of audit records including a final audit record are written to a first log file stored by a data processing system. A respective first hash value of each audit record is calculated. Responsive to calculating each respective first hash value, a corresponding second hash value is calculated from the first hash value and a value of a register associated with the data processing system. The second hash value is written to the register. A second log file is opened in response to closing the first log file. A final second hash value corresponding to a first hash value of the final audit record is written to a first record of the second log file.

### BACKGROUND OF THE INVENTION

1. Technical Field

The present invention relates generally to an improved data processing system and in particular to a data processing system and method for generating source verifiable audit logs. Still more particularly, the present invention provides a processing routine for logging a sequence of audit records in a plurality of log files as a source verifiable contiguous sequence of audit records.

2. Description of Related Art

Many data processing systems maintain highly confidential information such as financial applications, corporate confidential information, and the like, where many user terminals are connected in a distributed processing network. Data files are often stored on storage devices which are commonly accessible by a plurality of data processing systems connected in the network. The diversity of networked system devices at which access can be had to the various data files stored throughout the network presents a significant security problem.

Audit logging mechanisms are often deployed in networked data processing systems. A data processing system in a network runs an audit logging application that monitors the data processing system for an audit event, such as an unauthorized access attempt of a file. When the audit event is detected, an audit record is generated that includes attributes of the audit event, such as the time of the audit event, an identification of the user that attempted access of the file, and the like. The audit record is then stored in a log file maintained by the data processing system.

Periodically, the log file is closed and saved. Typically, an audit log is transmitted to a central repository, such as a network server, for storage and analysis by network personnel. When the log file is closed, a new log file is generated and subsequent audit events are stored in the new log file until it is closed and transmitted to the network repository.

The veracity of an audit log file is often critical in various situations. For example, the data processing system that generated the log file often must be conclusively identified for the log file to be admissible as evidence in a court of law. Otherwise, the audit log file may be found as hearsay and thus useless when prosecuting or taking other legal action against a person having committed illegal or unauthorized actions recorded by the audit log.

Thus, it would be advantageous to provide an auditing application that associates an identification of a data processing system with audit log files generated by the data processing system. It would further be advantageous to provide an auditing application that associates a sequence of audit log files with one another such that audit records in the sequence of audit log files are verifiable as a contiguous sequence of records. It would be further advantageous to provide a routine for conclusively verifying that a source identification is associated with the data processing system.

### SUMMARY OF THE INVENTION

The present invention provides a method, computer program product, and a data processing system for logging audit events in a data processing system. A sequence of audit records including a final audit record are written to a first log file stored by a data processing system. As the audit records are written to the audit log, a respective first hash value of each audit record is calculated. Responsive to calculating each respective first hash value, a corresponding second hash value is calculated from the first hash value and a value of a register associated with the data processing system. The second hash value is written to the register. A second log file is opened in response to closing the first log file. A final second hash value corresponding to a first hash value of the final audit record is written to a first record of the second log file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented according to a preferred embodiment of the present invention;

FIG. 2 is a block diagram of a data processing system that may be implemented as a server in accordance with a preferred embodiment of the present invention;

FIG. 3 is a block diagram illustrating a data processing system in which the present invention may be implemented according to a preferred embodiment of the present invention;

FIG. 4 is a block diagram of an auditing application and trusted platform module interface for generating audit log files in accordance with a preferred embodiment of the present invention;

FIG. 5A is a flowchart of processing performed by an auditing application in accordance with a preferred embodiment of the present invention;

FIG. 5B is a flowchart depicting processing steps performed by a trusted platform module when extending a platform configuration register value with an audit record in accordance with a preferred embodiment of the present invention;

FIG. 6A is a diagrammatic illustration of a log file to which audit records are written in accordance with a preferred embodiment of the present invention;

FIG. 6B is a diagrammatic illustration of a subsequent log file opened after closing the log file of FIG. 5A according to a preferred embodiment of the present invention; and

FIG. 7 is a flowchart of processing performed by a validation routine for validating audit log files in accordance with a preferred embodiment of the present invention.

### DETAILED DESCRIPTION OF THE PREFERRED EMBODIMENT

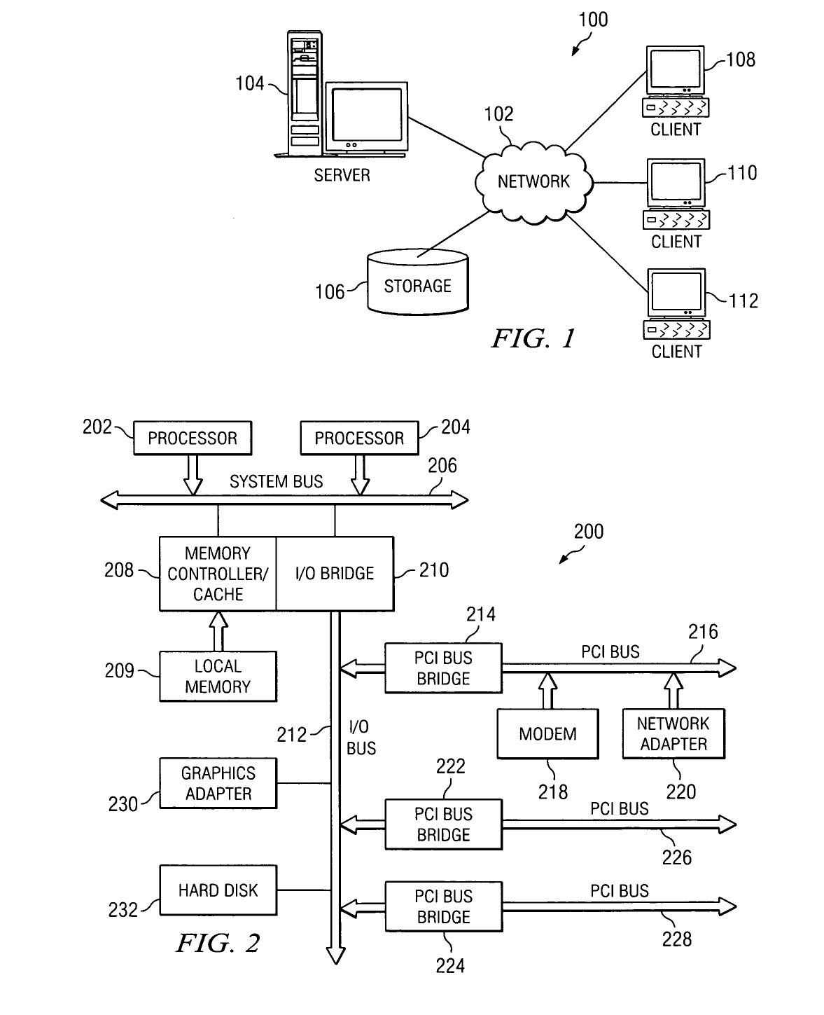

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

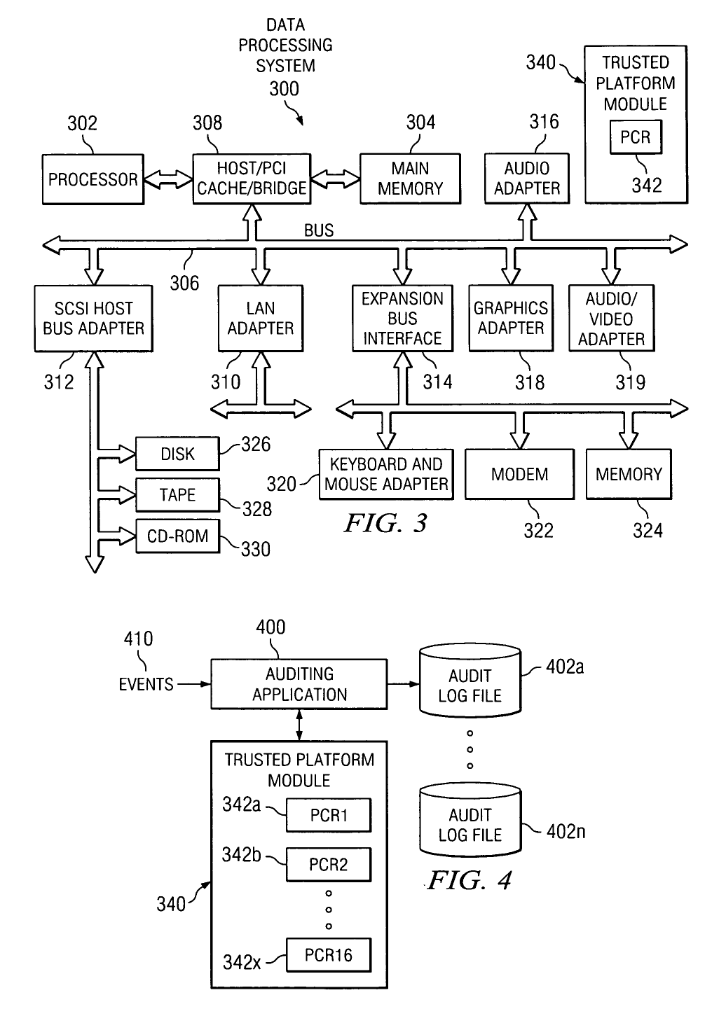

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, audio/video adapter 319, trusted platform, or computing, module (TPM) 340 having platform configuration registers (PCR) 342 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram of an auditing application and TPM interface for generating audit log files in accordance with a preferred embodiment of the present invention. Auditing application 400 is implemented as a set of computer executable instructions that may be stored in main memory 304 and executed by processor 302 of data processing system 300 shown in FIG. 3. Auditing application 400 identifies audit events 410 for logging in audit log files 402a-402n. Auditing application 400 interfaces with TPM 340. TPM 340 includes a plurality of platform configuration registers 342a-342x. In accordance with TPM specifications, TPM 340 has a unique 2048-bit identity referred to as an attestation key identity. The attestation identity key is unique to TPM 340 and thus provides a unique identification of data processing system 300.

In accordance with a preferred embodiment of the present invention, auditing application 400 utilizes one of the plurality of PCRs 342a-342x for sequentially storing hash values derived from audit records. As audit records are added to a log file, the audit record is hashed, and the hash value of the audit record is conveyed to TPM 340. TPM 340 provides a function referred to as TPM_Extend through which a PCR value may be modified. Specifically, the TPM_Extend function concatenates a value of a PCR addressed by the TPM_Extend function call and hashes the concatenation. The hashed value of the concatenation is then written as a new value of the PCR addressed by the TPM_Extend function call. In accordance with a preferred embodiment of the present invention, hash values of audit records calculated by auditing application 400 are conveyed to TPM 340 as operands of a TPM_Extend function call. TPM 340, in turn, concatenates a PCR value with the audit record hash and generates a hash of the concatenation results. The hash value of the concatenation is then stored in the PCR. Any non-reserved PCR may be used by auditing application 400, and as referred to below, a PCR refers to the particular platform configuration register addressed by auditing application 400. A non-reserved PCR used by auditing application 400 is referred to as PCR 342 in the Figures below.

Auditing application 400 automatically opens or generates a new audit log file when a log file is closed. The PCR value at the time the new log file is opened is cryptographically signed to produce a signature, and both the signature and the PCR value are stored as a first record of the new log file. New audit events are then recorded in the newly opened audit log file. Thus, a final audit record of one log file and a first audit record of a subsequent log file can be verified to comprise consecutive audit records recorded on the data processing system running auditing application 400. Moreover, recording the PCR signature in the newly opened audit log file provides a mechanism for verifying the source data processing system that generated the log file by way of the physical association of TPM 340 with data processing system 300.

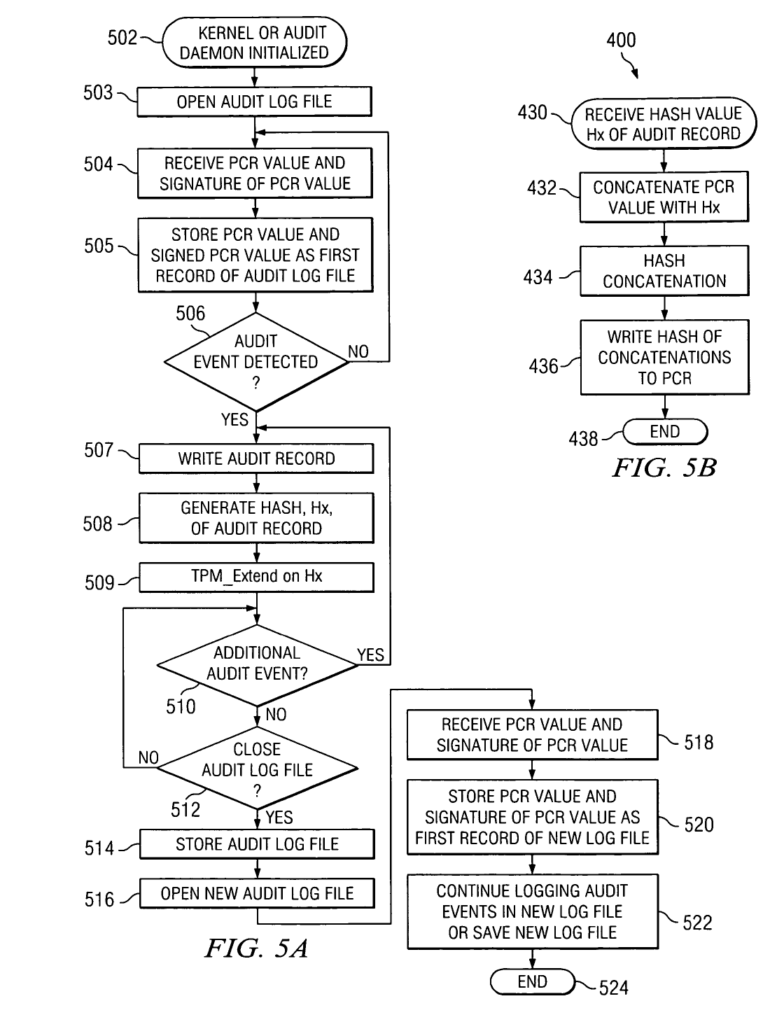

FIG. 5A is a flowchart 500 of processing performed by auditing application 400 of FIG. 4 in accordance with a preferred embodiment of the present invention. Auditing application 400 is initialized, e.g., at system boot, and awaits an audit event to be logged (step 502). Auditing application 400 is implemented as a computer program product comprising one or more executable instruction sets that may be stored on hard disk 326 of data processing system 300 of FIG. 2 and processed by a processor, such as processor 302. For example, auditing application 400 may be implemented with the operating system kernel. Alternatively, the auditing application may be implemented as a daemon that monitors system events for an audit event to be logged.

An audit log file is opened (step 503) and the value of PCR 342 is read (step 504). For example, a TPM_Quote function call may be performed on PCR 342. Execution of the TPM_Quote function returns the PCR value, a signature of the PCR value, and the signature size. In accordance with TPM standards, the PCR signature is generated by signing the PCR value with the TPM attestation identity key. The PCR value and the PCR signature are then stored as the first record of the newly opened audit log file (step 505). The signature size may be stored in the first record of the newly opened audit log file as well. The auditing application then begins monitoring for detected audit events (step 506). Alternatively, in the event that auditing is to be suspended, for example on a system shutdown, the audit log file may be closed and stored after step 505.

When an event is identified that satisfies one or more audit criterion, an audit record is written to the open audit log file (step 507). The audit record is a record of one or more attributes of the audit event being logged, for example time of audit event, a source, such as a user or source device address, responsible for generation of the audit event, a file name of a file subjected to an unauthorized access attempt, or the like. The audit log file is maintained in a memory storage, such as main memory 304 of data processing system 300 of FIG. 3.

After writing the audit record to the audit log file, a hash of the record is generated by auditing application 400 (step 508). For example, auditing application 400 may include or call the well known US secure hashing algorithm-1 (SHA1) to hash the audit record. The hash value of the audit record (designated Hx where x identifies the particular record of the audit log file that is hashed) itself is then concatenated with the value of the PCR addressed by a TPM_Extend function called by auditing application 400, and the concatenation is hashed by TPM 340 (step 509). For example, the hash value Hx is conveyed to TPM 340 as an operand of a TPM_Extend function call. Other operands, such as a PCR identifier (pcrNum) that specifies the PCR to be extended, in addition to the hash value Hx are conveyed to TPM 340 for executing the TPM_Extend function. The hash value of the concatenation is then written as a new value of the specified PCR according to the TPM_Extend functionality.

Auditing application 400 may then poll for an additional audit event to log (step 510). If a new audit event is identified by auditing application 400, processing returns to step 507 and a new record is written to the log file. If no new audit event is identified at step 510, auditing application 400 may determine whether the audit log file is to be closed (step 512). Processing returns to step 510 if the audit log file is to remain open.

When the auditing application determines that the audit log file is to be closed, the log file is stored (step 514). For example, the log file may be written to hard disk 326 of client 300 shown in FIG. 3. Alternatively, the log file may be communicated to a network storage device such as a database maintained in hard disk 232 of data processing system 200 of FIG. 2.

A new log file is then opened (step 516). The PCR value and a signature of the PCR value are then received by auditing application 400 by, for example, execution of a TPM_Quote function (step 518). The PCR value and the PCR signature are then stored as the first record of newly opened log file (step 520). Thus, the PCR value stored as the first record of the newly opened audit log file is the value of the PCR at the time the previous audit log file was closed. Auditing may then be continued by adding new audit log records to the new log file, or the new log file may be saved for later retrieval and recording of future audit events (step 522). The auditing application then exits if auditing is to be suspended (step 524).

FIG. 5B is a flowchart depicting processing steps performed by TPM 340 when extending the PCR value with an audit record of the audit log file in accordance with a preferred embodiment of the present invention. The processing steps shown in FIG. 5B generally correspond to step 509 of FIG. 5A. The hashed audit record Hx is received by TPM 340 with a TPM_Extend function call (step 530). TPM 340 concatenates the PCR value with the hashed audit record Hx (step 532). The results of the concatenation operation are then hashed (step 534). In accordance with TPM specifications, a hash of a PCR value during a TPM_Extend operation is performed by a SHA1 hash function. The SHA1 hash value of the concatenation result is then written to the PCR (step 536) and the extend operation of the PCR ends (step 538). Accordingly, as additional audit records are written to an audit log file, a PCR value is sequentially updated by deriving a new PCR value from the latest audit log record hash and the previous PCR value.

Thus, a corresponding PCR value is produced as a function of the generated audit record and a previous PCR value as audit records are generated. By signing the final PCR value with an identity associated with the data processing system generating the audit log and storing the signed PCR value as the first record of a new log file, a sequential association between the final record of a first log file and a first record of the new log file is made. Advantageously, consecutive audit log files generated by the auditing application provide a verifiable contiguous sequence of records of audit events.

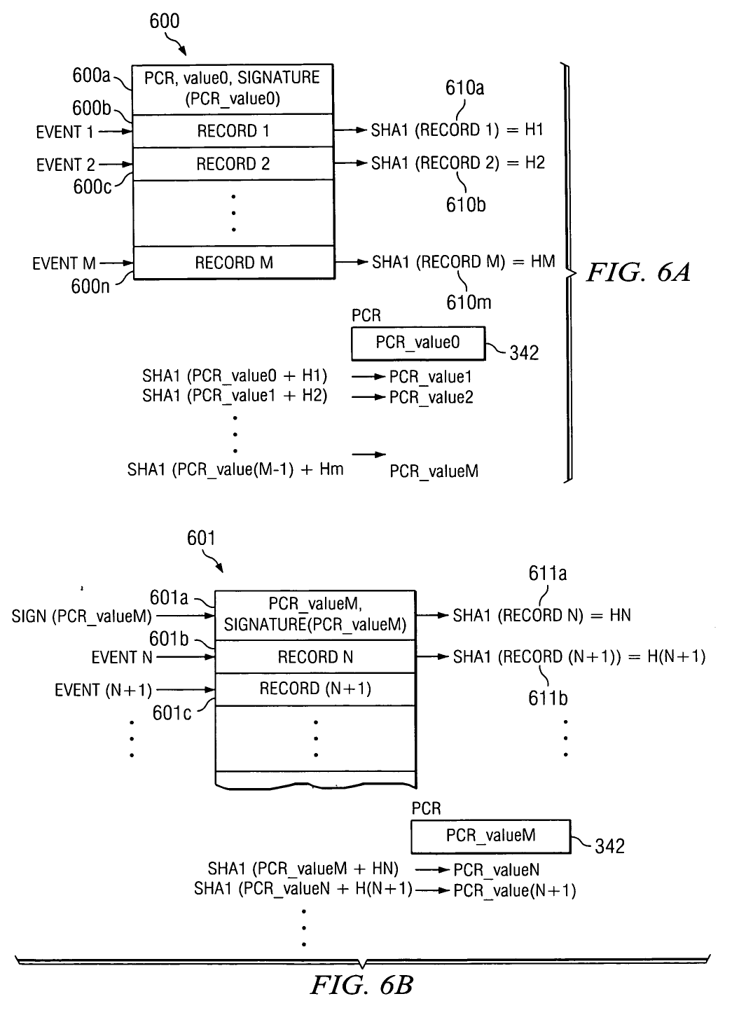

FIG. 6A is a diagrammatic illustration of a log file to which audit records are written in accordance with a preferred embodiment of the present invention. For illustrative purposes, assume audit log file 600 is generated by auditing application 400 running on data processing system 300 of FIG. 3. Audit log file 600 includes records 600a-600n. Record 600a stores the value of PCR 342 (designated PCR_value0) at the time log file 600 is opened. Additionally, record 600a stores the signature of PCR_value0. The signature size may be stored in record 600a as well. Records 600b-600n store audit data corresponding to audit events Event1-EventM detected on data processing system 300. On detection of a first audit event (Event1), record 600b is written to log file 600 and a SHA1 hash 610a of record 600b is generated by auditing application 400. In the illustrative examples, the SHA1 hash of an audit record is designated Hx, where x designates the audit record from which the hash is generated. Additionally, the first record of log file 600a is considered the 0^{th} record. Thus, hash 610a of record 600b is designated H1. In the illustrative example, the initial value of PCR 342 is designated as PCR_value0. Upon hashing audit record 600b, auditing application 400 conveys hash value 610a to TPM 340 in a TPM_Extend function call. TPM 340 concatenates hash value 610a generated by auditing application 400 with initial PCR value PCR_value0 and hashes the concatenated value. The hashed concatenation value PCR_value1 is then written to PCR 342.

As additional audit events (Event2-EventM) are detected by auditing application 400, records 600c-600n are added to log file 600. Hash values 610b-610m are generated for each record 600c-600n. For each audit record hash value 610b-610m, corresponding concatenations of the audit record hash values and PCR values (PCR_value1−PCR_value(M−1)) are calculated. The results of the concatenations are then hashed, and the hash values (PCR_value2−PCR_valueM) of the concatenations are generated and written to PCR 342 by respective TPM_Extend function calls. Thus, as audit events are logged, the PCR value is updated by a derivation of the most recent audit record and the PCR value at the time the audit event is logged.

In the illustrative example, a final hash value (HM) 610m is generated from last record 600n of log file 600. A corresponding final PCR value PCR_valueM associated with log file 600 is then generated by hashing the concatenation of the previous PCR value PCR(M−1) and audit record hash value 610m.

For illustrative purposes, assume log file 600 is closed after writing final record 600n to log file 600. Log file 600 is then stored, for example, by communicating log file 600 to data processing system 200 for storage in accordance with step 514 of FIG. 5A. New log file 601 is opened according to step 516 of FIG. 5A as shown by the diagrammatic illustration of new log file 601 in FIG. 6B. The final PCR value (PCR_valueM) associated with log file 600 is then signed by a TPM_Quote function call issued by auditing application 400. PCR_valueM and the signature of PCR_valueM are then stored as first record 601a of new log file 601. Additionally, a signature size may be stored in first record 601a of log file 601. In a preferred embodiment, the PCR value is signed with the attestation identity key of TPM 340 by a TPM_Quote function call issued by auditing application 400. Storage of the signature of the PCR value read from PCR 342 when log file 600 is closed as a first record of log file 601 provides a mechanism for later verifying that final record 600n of log file 600 and a first audit record logged of subsequently opened log file 601 are records of consecutive audit events. Moreover, signature of the PCR value with the attestation key identity of TPM 340 provides an accurate verification that log file 601 was generated by data processing system 300.

Log file 601 may then be stored if auditing application 400 is being closed, e.g., if audit log file 600 was closed in response to a system shutdown event. Alternatively, additional audit records 601b-601c may be written to log file 601 as additional audit events are identified and corresponding hash values 611a-611b are generated. Hash values 611a-611b are used in a similar manner as those described above for updating PCR 342 with values derived from the most recent audit record that has been logged. Audit events detected after generation of audit log file 601 are added to log file 601 as described with reference to FIGS. 5A and 5B until log file 601 is closed.

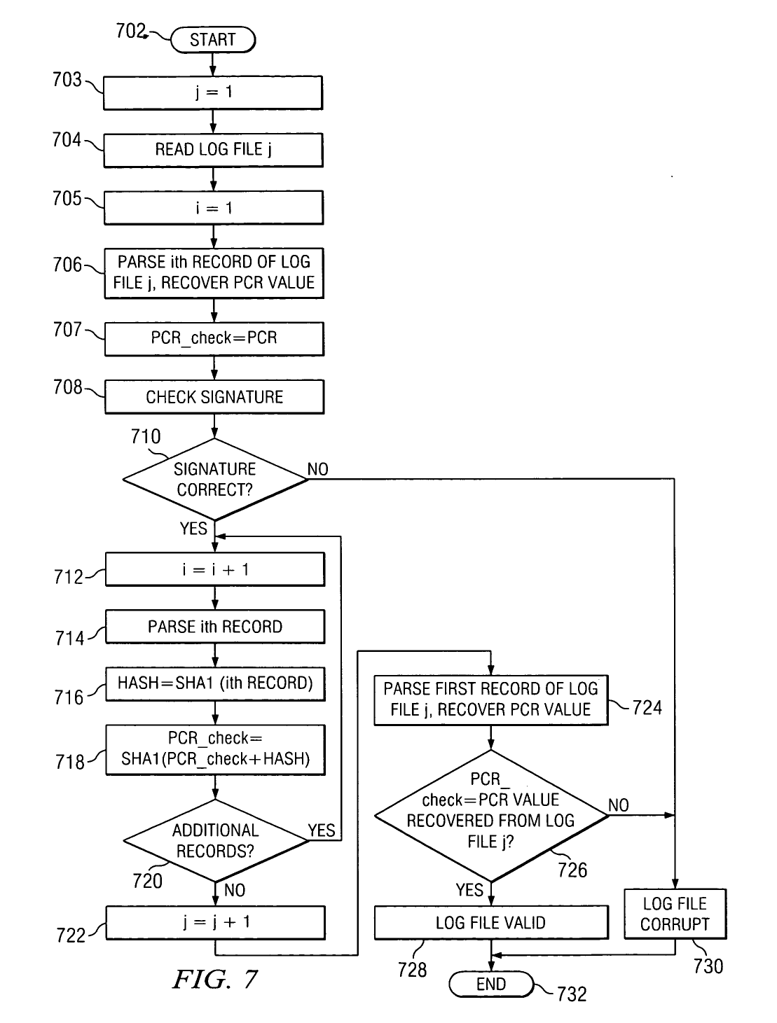

FIG. 7 is a flowchart of processing performed by a validation application in accordance with a preferred embodiment of the present invention. The validation application may be implemented as a set of computer executable instructions retrieved and processed by, for example, processor 202 of data processing system 200. For example, a plurality of log files may be generated by data processing system 300 and stored on data processing system 200 where the log files are validated and archived on hard disk 232. Alternatively, the validation application may be implemented as a subroutine of auditing application 400 of FIG. 4.

To verify an audit log file was written by data processing system 200 and the verify the accuracy of the audit records of the audit log file, the validation application parses the PCR value and the signature stored in the first audit record of the audit log file being evaluated. The parsed signature is then evaluated. If the signature is validated, the validation application then parses the PCR value stored in the second record, calculates a hash of the PCR value parsed from the second record, and concatenates the calculated hash with the PCR value parsed from the previous record. The validation application then hashes the concatenation. The validation application repeats the process by sequentially stepping through each record until a final hash value is calculated from a concatenation of a hash of the final record and the PCR value calculated from the previous record. The final hash value may then be compared with the PCR value stored in the first record of the next audit log file in a sequence of stored audit log files. If the compared values match, the evaluated log file is then authenticated.

The validation application is started (step 702) and a log file index variable j is initialized to 1 (step 703). A log file j to be validated is then read (step 704). A record index variable i is then initialized to 1 (step 705), and record i is parsed from log file j (step 706). Parsing the first record of log file j results in recovery of the PCR value when log file j was created and the signature generated from the PCR value and the attestation key identity of data processing system 300. A PCR_check variable is set to the PCR value parsed from the first record of log file j (step 707). The signature is then evaluated (step 708) and checked for correctness (step 710). If the signature is not correct, the log file j is determined to be corrupt (step 730) and the validation routine may then exit (step 732).

If the signature is evaluated as correct at step 710, the validation algorithm proceeds to increment the record index variable i (step 712) and parse the i^{th} record of log file j (step 714). A SHA1 hash (Hash) is calculated from the log file record i (step 716). The hash value is then concatenated with the parsed PCR value (PCR_check) and a SHA1 hash of the concatenation is calculated and stored as a new PCR_check value (step 718). Log file j is then evaluated to determine if additional audit records exist. If additional audit records remain in log file j, processing returns to step 712 where the record index viable i is incremented.

When each record has been hashed and a corresponding PCR_check value has been calculated, the validation routine proceeds to increment the log file index variable j (step 722). The next log file j is read and the first record is parsed (step 724). The PCR value of the first record is recovered from the parsed first record and indicates the PCR value of the TPM when log file j was created. The final PCR_check value calculated from the evaluated log file is then compared with the parsed PCR value of log file j (step 726). If the PCR_check value is equivalent to the parsed PCR value of log file j, the evaluated log file (log file j−1) is determined to be valid (step 728). Otherwise, the evaluated log file is determined to be corrupt (step 730). The validation routine may then exit (step 732). Alternatively, the validation algorithm may repeat for a validation analysis of the current log file j.

Thus, an auditing application that associates an identification of a data processing system with audit log files generated by the data processing system is provided. A platform configuration register is iteratively derived from sequential audit records as the audit records are generated. An attestation identity key of a trusted platform module is used for generating a signature of a platform configuration register value. The signature is generated by signing the value of the platform configuration register upon closing a first log file. The signature is saved with the platform configuration register value as a record of a subsequent log file used for recording audit records. Thus, a data processing system is verifiable as a source of sequentially generated logs files. Moreover, audit events of a log file and audit events of a subsequently generated log file are verifiably a contiguous sequence of audit records.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of logging audit events in a data processing system, the method comprising the computer implemented steps of:
writing a sequence of audit records including a final audit record to a first log file stored by a data processing system;
calculating a respective first hash value of each audit record;
responsive to calculating each respective first hash value, calculating a corresponding second hash value from the first hash value and a value of a register associated with the data processing system;
writing the second hash value to the register;
responsive to closing the first log file, opening a second log file; and
writing, to a first record of the second log file, a final second hash value corresponding to a first hash value of the final audit record.

2. The method of claim 1, further comprising:
generating a cryptographically signed value of the final second hash value; and
writing the signed value to the first record of the second log file.

3. The method of claim 2, wherein the signed value is generated using an identity of a trusted platform module of the data processing system.

4. The method of claim 1, wherein each respective first hash value and corresponding second hash value are calculated from a US secure hashing algorithm-1.

5. The method of claim 1, wherein writing the second hash value further comprises:
performing an extend function, wherein the first hash value is included as an operand of an extend function call and the register is a platform configuration register.

6. The method of claim 1, wherein calculating a corresponding second hash further comprises:
concatenating the register value with the first hash value; and
calculating the second hash value from a result of concatenating the register value with the first hash value.

7. A method for verifying a source of a log file, the method comprising the computer implemented steps of:
iteratively calculating a respective first hash value of a plurality of records of a first log file;
responsive to calculating the respective first hash value, calculating a corresponding second hash value from the first hash value and a second value;
responsive to calculating each second hash value, storing the second hash value as the second value;
responsive to calculating a first hash value and a corresponding second hash value for a final record of the plurality of records, comparing the second hash value of the final record to a value stored in a record of a second log file.

8. The method of claim 7, wherein iteratively calculating further comprises:
calculating an initial first hash value, wherein the second value is a stored value of a register read when the first log file is created.

9. The method of claim 7, further comprising:
reading a first record of the first log file, wherein the first record includes an initial value of the second value.

10. A computer program product in a computer readable medium for recording audit events, the computer program product comprising:
first instructions for writing a first sequence of records to a first log file and for writing a second sequence of records to a second log file, wherein the records of the first sequence include a final record;
second instructions for calculating a respective first hash value of each record of the first sequence;
third instructions for calculating a second hash value from the first hash value of the final record, wherein the second hash value is calculated from a hash of the first hash value of the final record and a value of a register; and
fourth instructions for writing the second hash value of the final record to a record of the second log file.

11. The computer program product of claim 10, wherein the first instructions open the second log file upon closing the first log file.

12. The computer program product of claim 11, wherein the third instructions read the value of the register when the first log file is closed.

13. The computer program product of claim 10, wherein the fourth instructions write a cryptographically signed value of the value of the register to the record of the second log file.

14. The computer program product of claim 10, wherein the third instructions calculated a respective second hash value for each first hash value.

15. The computer program product of claim 14, wherein the third instructions write the second hash value to the register upon calculating the respective second hash value for each first hash value.

16. A data processing system for recording audit events, comprising:
a memory that contains a first audit log file and an auditing application as a set of instructions;
a trusted platform module having a platform configuration register; and
a processing unit, responsive to execution of the set of instructions, for calculating a hash value of an audit record written to the first audit log file and that extends a value of the platform configuration register with the hash value, wherein the processing unit, responsive to closing the first log file, identifies a final value of the platform configuration register and writes the final value to a second audit log file.

17. The data processing system of claim 16, wherein the final value is derived from a hash value calculated from a final audit record written to the first audit log file and a value of the platform configuration register identified after writing the final audit record.

18. The data processing system of claim 16, wherein the processing unit calculates a signature of the final value and writes the signature to the second audit log file.

19. The data processing system of claim 16, wherein the signature is generated from an attestation identity key of the trusted platform module.

20. The data processing system of claim 16, wherein the processing unit writes a final audit record to the first audit log file and an audit record generated subsequent to the final audit record to the second audit log file.
